(19) United States
(12) Patent Application Publication
(10) Pub. No.: US 2013/0050277 A1
(43) Pub. Date: Feb. 28, 2013

(54) DATA TRANSMITTING MEDIA, DATA TRANSMITTING DEVICE, AND DATA RECEIVING DEVICE

(71) Applicants: HAN-CHE WANG, Tu-Cheng (TW); CHIH-SAN CHIANG, Tu-Cheng (TW); HUA-DONG CHENG, Shenzhen City (CN)

(72) Inventors: HAN-CHE WANG, Tu-Cheng (TW); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/271,251

(22) Filed: Oct. 12, 2011

(30) Foreign Application Priority Data
Aug. 31, 2011 (CN) 201110254653.9

(51) Int. Cl. G09G 5/32

(52) U.S. Cl. 345/676

(57) ABSTRACT

A data transmitting device communicating with a data receiving device includes a touch display unit displaying a plurality of icons and a control unit. The controlling module determines a first starting position, a touch path, and a first end position of a touch of a user, and a selected icon according to the first starting position, and calculates a transmission progress of data transmission. When the first end position is located on the predetermined position, the data corresponding to the selected icon and position information associated with the first starting position, the touch path, and the first end position are transmitted to the data receiving device. The selected icon is moved from the first starting position to the first end position along the touch path according to the transmission progress. A data transmitting device and a data transmitting media are also provided.

### BACKGROUND

1. Technical Field

The present disclosure relates to data transmitting technology, and particularly, to a data transmitting media capable of displaying data transmitting progress, a data transmitting device, and a data receiving device involved in the data transmitting process.

2. Description of the Related Art

By conventional data transmitting methods, when attempting to transmit data from an electronic device, such as a computer, to an external device, such as a mobile phone, a typical data transmission progress window may be displayed to show data transmission progress. This progress window is not intuitive.

### BRIEF DESCRIPTION OF THE DRAWINGS

The components in the drawing are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a data transmitting media capable of displaying data transmitting progress, in accordance with an exemplary embodiment.

FIG. 2 is a schematic view showing a first using state of the data transmitting media in FIG. 1.

FIG. 3 is a schematic view showing a second using state of the data transmitting media in FIG. 1.

FIG. 4 is a schematic view showing a using state of the data transmitting media in accordance with another exemplary embodiment.

FIG. 5 is a flowchart of a method for a data transmitting media capable of displaying data transmitting progress in accordance with an exemplary embodiment.

### DETAILED DESCRIPTION

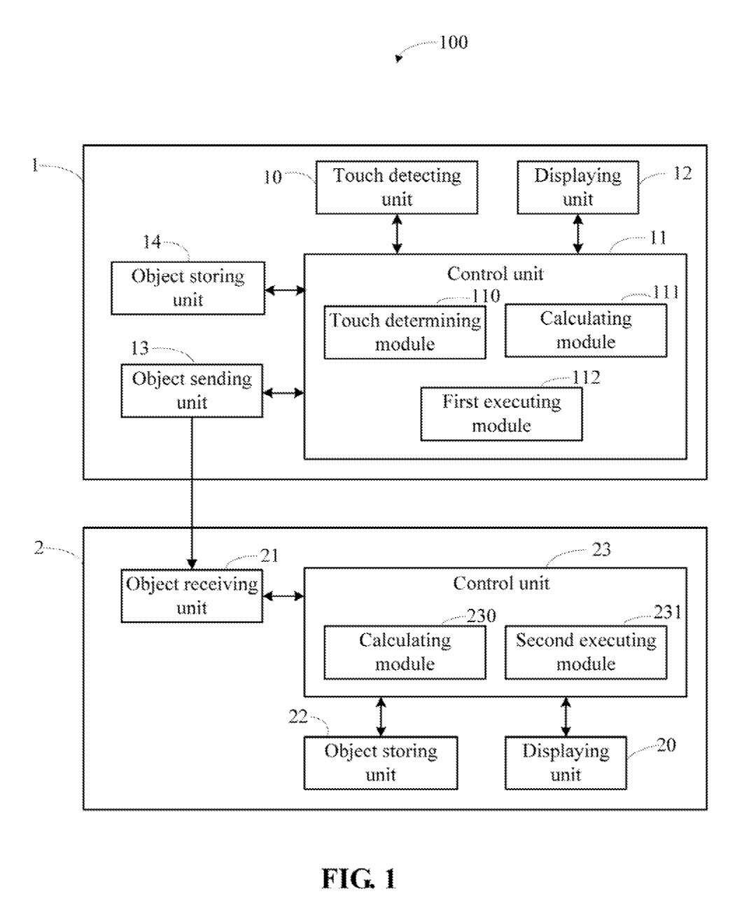

FIG. 1 is a block diagram of a system 100 capable of showing data transmission progress. The data may be a file or a file folder. The system 100 includes a data transmitting device 1 and a data receiving device 2 communicating with the data transmitting device 1. The data transmitting device 1 and the data receiving device 2 may be PDAs or E-books.

The device 1 includes a touch detecting unit 10, a control unit 11, a display unit 12, a data transmitting unit 13, and a storage unit 14. The display unit 12 may be a touch screen. The touch detecting unit 10 generates touch signals in response to the touch of a user on the display unit 12.

The control unit 11 includes a touch determining module 110 and an executing module 112. The touch determining module 110 determines a first starting position, a touch path, and a first end position of the touch of a user according to the touch signals from the touch detecting unit 10. The touch path may be a user's touch track, or any predefined type of touch path between the first starting position and the first end position, for example, the touch path is the shortest path between the first starting position and the first end position. The executing module 112 determines which icon displayed on a first user interface of the display unit 12 is selected according to the first starting position, and mark the selected icon, for example, highlight the selected icon.

The executing module 112 further determines whether the first end position is on the edge/boundary of the first user interface, and controls the data transmitting unit 13 to transmit the data corresponding to the selected icon, position information associated with the first starting position, the touch path, and the first end position to the receiving device 2, if the first end position is on the edge/boundary of the first user interface. In the embodiment, the first user interface occupies the entire display area of the display unit 12. The storage unit 14 stores a variety of data.

The control unit 11 further includes a calculating module 111. The calculating module 111 calculates a first transmission progress according to the size of selected data, a transmission speed, and a transmission time. The executing module 112 moves the selected icon from the first starting position to the first end position along the touch path according to the transmission progress. The selected icon gradually merges into the edge/boundary of the first user interface and finally disappears when the transmission is finished.

The receiving device 2 includes a display unit 20, a data receiving unit 21, a storage unit 22, and a control unit 23. The display unit 20 may be a touch screen. The data receiving unit 21 receives the selected data, the position information associated with the first starting position, the touch path, and the first end position from the transmitting device 1. The control unit 23 includes a calculating module 230 and a second executing module 231. The calculating module 230 determines a second starting position, a moving path, and a second end position according to the position information associated with the first starting position, the touch path, and the first end position. The icon corresponding to the received data is preset to be displayed on the second starting position when the data transmission starts, and gradually moves to the second end position along the moving path during data transmission.

The calculating module 230 further calculates a second transmission progress according to the size of selected data, a transmission speed, and a transmission time. The second executing module 231 moves the selected icon from the second starting position to the second end position along the moving path according to the second transmission progress. The storage unit 22 stores the received data.

In the embodiment, the display unit 12 and the display unit 20 are both touch screens. The resolutions of the two touch screens are the same.

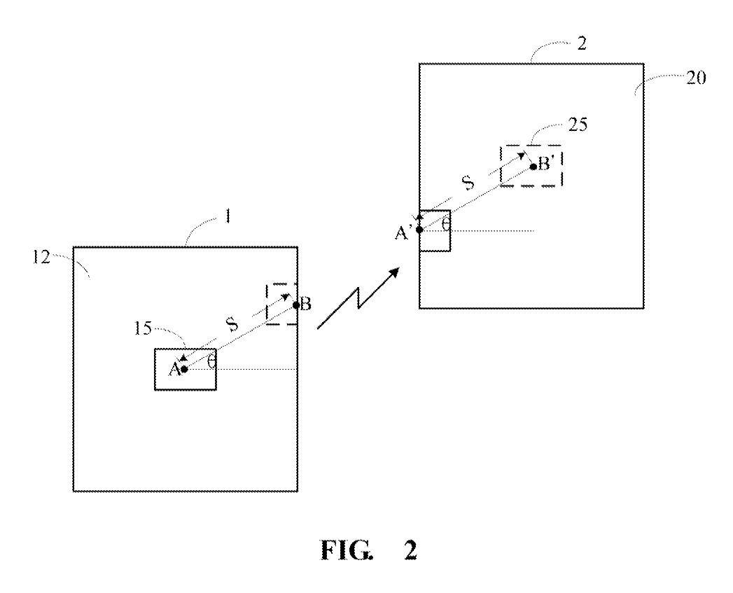

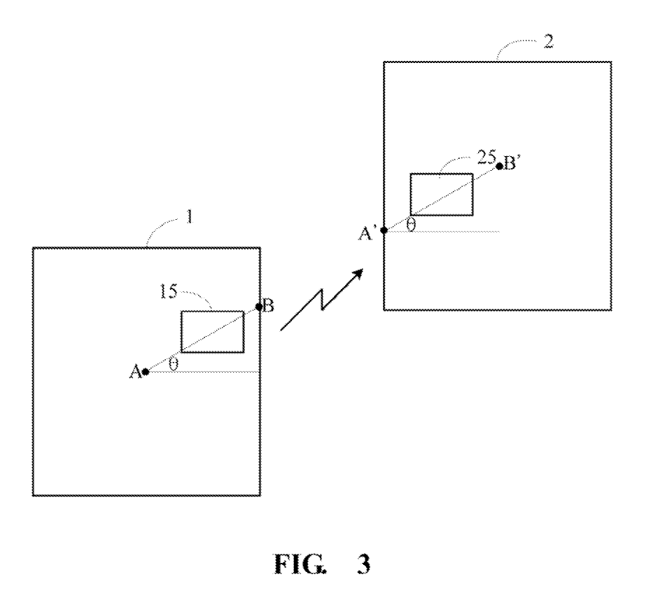

FIGS. 2-3 are schematic views employed to illustrate the transmission progress. An icon 15 is displayed on the first user interface. When a user touches the icon 15 and the drags to the edge/boundary of the first user interface, the touch detecting unit 10 generates touch signals in response to the operation of the user. The touch determining module 110 determines the first starting position A, the touch path, and the first end position B of the user's touch according to the touch signals from the touch detecting unit 10, and determines data corresponding to the icon 15 is selected to be transmitted. The data transmitting unit 13 is started to transmit the data to the receiving device 2.

In the embodiment, the touch determining module 110 determines the coordinate of the first starting position A is (a, b), the coordinate of the first end position B is (a′, b′), and a first angle formed between a horizontal line including the first staring position A and the touch path is θ. The executing module 112 controls the data transmitting unit 13 to transmit the data associated with the icon 15, the coordinate of the first starting position A, the coordinate of the first end position B and the first angle θ to the receiving device 2. The calculating module 111 determines the already transmitted size G of the data corresponding to the icon 15 according to the formula G=V*T, where V is the transmission speed V and T is the undergoing transmission time T. Thus, the calculating module 111 determines the first transmission progress P according to the formula P=G/Q, where Q is the total size of the data. Furthermore, the calculating module 111 determines a first displacement S between the first starting position A and the first end position B according to the coordinates A (a, b) and B (a′, b′). Then, the executing module 112 moves the icon 15 from the first starting position A to the first end position B along the touch path according to the first transmission progress P and the first displacement S during data transmission. When data transmission is finished, the icon 15 is moved to the first end position B and disappears.

When the data receiving unit 21 receives the data, the coordinate of the first starting position A, the coordinate of the first end position B, and the first angle θ, the second executing module 231 controls the display unit 20 to display the second user interface. The calculating module 230 determines the second starting position A′, the moving path, and the second end position B′ according to the first starting position A, the touch path, and the first end position B. In the embodiment, the coordinate of the second end position B′ displayed on the second user interface is preset to be equal to that of the first starting position A. A second angle formed between a horizontal line including the second starting position and the second end position is equal to the first angle. Thus, the coordinate of the second end position B′ is (a, b). The calculating module 230 determines a first displacement S between the first starting position A and the first end position according the coordinates A (a, b) and B (a′, b′), and determines the coordinate of the second starting position A′ is (c, d) according to the displacement S, the second angle, and the coordinate of the second end position B′.

The calculating module 230 determines the already received size G′ of the data corresponding to the icon 15 according to the formula G′=V*T, where V is the transmission speed and T is the undergoing transmission time T. Thus, the calculating module 230 determines the second transmission progress P′ according to the formula P′=G′/Q, where Q is the total size of the data. Furthermore, the calculating module 230 determines a second displacement S′ between the second starting position A′ and the second end position B′ according to the coordinates A′ (c, d) and B′ (a, b), then, the second executing module 231 moves the icon from the second starting position A′ to the second end position B′ along the moving path according to the second transmission progress P′ and the second displacement S′ during data transmission. When data transmission is finished, the icon 15 is moved to the second end position B′.

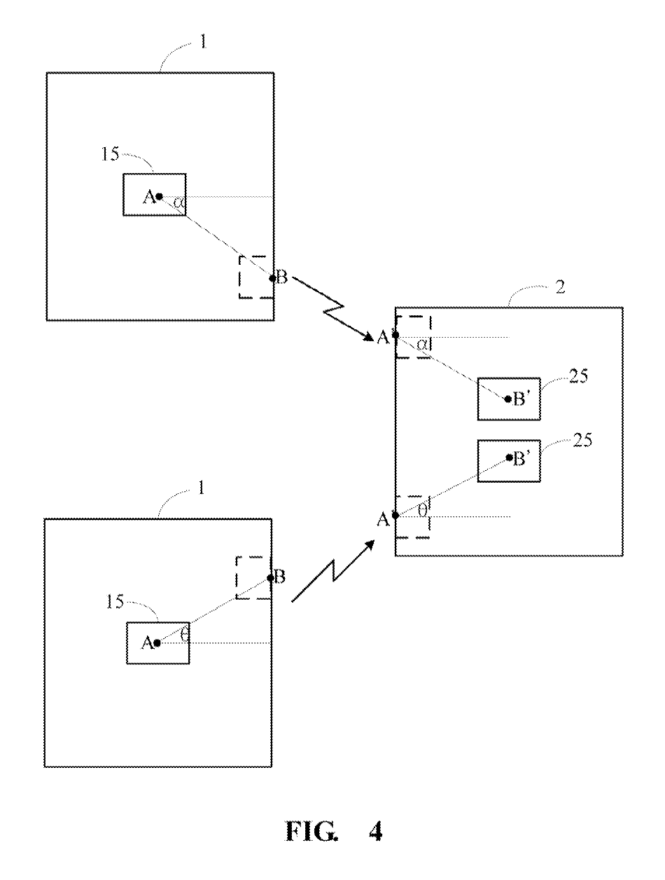

Referring to FIG. 4, in an alternative embodiment, the system 100 includes two transmitting devices 1 and a receiving device 2, and the two transmitting devices 1 communicate with the receiving device 2 at the same time. In the embodiment, the resolutions of the touch screens of the two transmitting devices 1 and the receiving device 2 are the same.

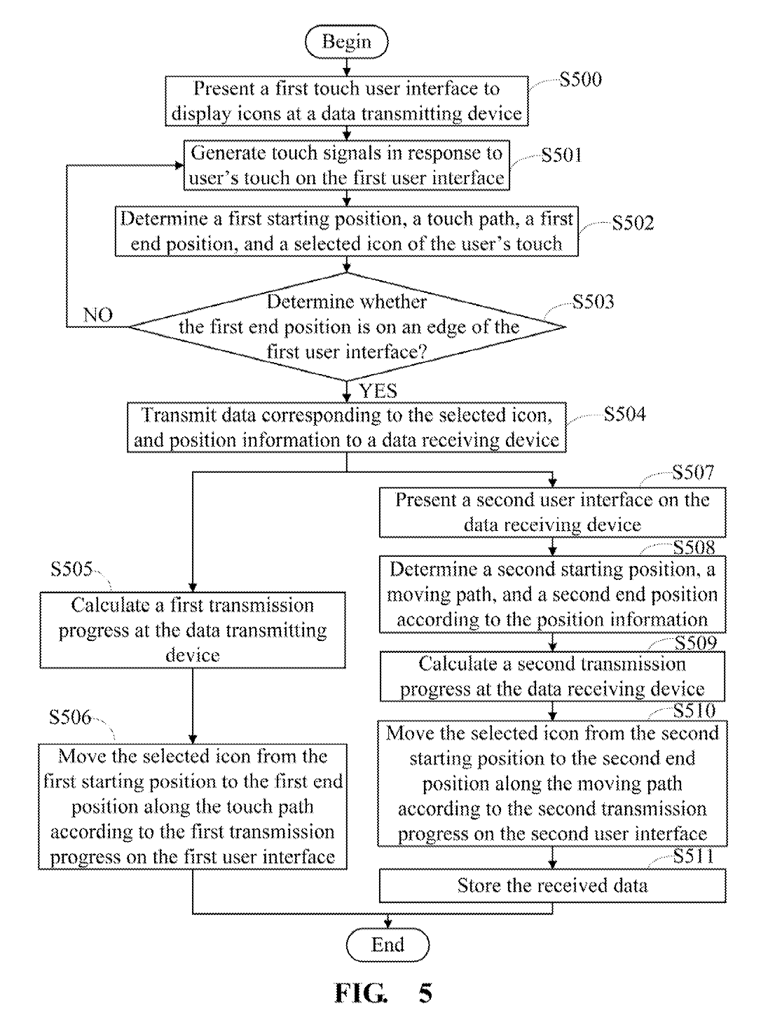

FIG. 5 is a flowchart of a method for a data transmitting media capable of displaying data transmission progress in accordance with an exemplary embodiment.

In step S500, the display unit 12 presents a first touch user interface to display a plurality of icons. The display unit 12 may be a touch screen.

In step S501, the touch detecting unit 10 generates touch signals in response to user's touch on the display unit 12.

In step S502, the touch determining module 110 determines the first starting position, the touch path, and the first end position of the touch of the user according to the touch signals from the touch detecting unit 10. In addition, determines which icon displayed on the first user interface of the display unit 12 is selected according to the first starting position. The touch path may be a touch track of a user, or any predefined type of path between the first starting position and the first end position, such as the shortest path between the first starting position and the first end position.

In step S503, the executing module 112 determines whether the first end position is on the edge/boundary of the first user interface, if yes, the procedure goes to step S504, otherwise, the procedure returns to S501.

In step S504, the executing module 112 controls the data transmitting unit 13 to transmit the data corresponding to the selected icon, position information associated with the first starting position, the touch path, and the first end position to the data receiving device 2.

In the embodiment, the first user interface occupies the entire display area of the display unit 12.

In step S505, the calculating module 111 calculates a first transmission progress according to size of selected data, a transmission speed, and a transmission time.

In step S506, the executing module 112 moves the selected icon from the first starting position to the first end position along the touch path according to the transmission progress.

At the same time going on the step S505, the method further includes:

In step S507, the second executing module 231 controls the display unit 20 to display a second user interface.

In step S508, the calculating module 230 determines a second starting position, a moving path, and a second end position according to the position information associated with the first starting position, the touch path, and the first end position received from the transmitting device 1.

In step S509, the calculating module 230 calculates a second transmission progress according to size of selected data, a transmission speed, and a transmission time.

In step S510, the second executing module 231 moves the selected icon from the second starting position to the second end position along the moving path according to the second transmission progress.

In step S511, the storage unit 22 stores the received data.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A data transmitting device comprising:
a touch display unit for displaying a plurality of icons;
a storage unit for storing a variety of data;
a data transmitting unit configured to communicate with a data receiving device;
a touch detecting unit configured to generate touch signals in response to user's touch on the display unit; and
a control unit comprising:
a touch determining module configured to determine a first starting position, a first touch path, and a first end position of the user's touch on the display unit according to the touch signals from the touch detecting unit, and determine a selected icon according to the first starting position;
a calculating module configured to calculate a transmission progress of data transmission from the data transmitting device to the data receiving device; and
an executing module configured to determine whether the first end position is located at a predetermined position, and control the data transmitting unit to transmit the data corresponding to the selected icon, and position information associated with the first starting position, the first touch path, and the first end position to the data receiving device if the first end position is located at the predetermined position, the executing module further configured to move the selected icon from the first starting position to the first end position along the touch path according to the transmission progress.

2. The device as recited in claim 1, wherein the user interface displayed on the display unit occupies the entire display area of the touch screen.

3. The device as recited in claim 2, wherein the predetermined position is located on the edge of the user interface on the display unit.

4. The device as recited in claim 1, wherein the calculating module is configured to calculate the transmission progress according to the size of selected data, a transmission speed, and a transmission time.

5. A data receiving device comprising:
a data receiving unit configured to receive a data corresponding to a selected icon, position information associated with a first starting position, a first touch path, and a first end position of the selected icon transmitted from a data transmitting device;
a control unit comprising:
a calculating module configured to determine a second starting position, a moving path, and a second end position according to the position information associated with the first starting position, the touch path, and the first end position, and calculate a transmission progress of data transmission; and
an executing module configured to display the selected icon on the second starting position on a display unit, and move the selected icon from the second starting position to the second starting position to the second end position along the moving path according to the second transmission progress; and
a storage unit configured to store the received data corresponding to the selected icon.

6. The device as recited in claim 5, wherein the calculating module is configured to calculate the transmission progress according to the size of selected data, a transmission speed, and a transmission time.

7. A data transmitting media comprising computer executable instructions, portions of the instructions to be executed in a data transmitting device and the remaining portions of the instructions to be executed in a data receiving device communicating with the data transmitting device, wherein the data transmitting device comprising a touch screen, the instructions, when being executed, implementing a method comprising:
A: presenting a first user interface on the touch screen of the data transmitting device to display a plurality of icons;
B: generating touch signals in response to user's touch on the first touch user interface;
C: determining a first starting position, a touch path, and a first end position of the user's touch according to the touch signals, and determining a selected icon according to the first starting position;
D: determining whether the first end position is located at a predetermined position;
E: transmitting the data corresponding to the selected icon, and position information associated with the first starting position, the touch path, and the first end position to the data receiving device using the data transmitting device if the first end position is located at the predetermined position;
F: calculating a first transmission progress of the data transmission using the data transmitting device; and
G: moving the selected icon from the first starting position to the first end position along the touch path according to the first transmission progress on the first touch user interface;
H: presenting a second user interface on the data receiving device, and determining a second starting position, a moving path, and a second end position according to the position information associated with the first starting position, the touch path, and the first end position received from the data transmitting device at the data receiving device;
I: calculating a second transmission progress of data transmission using the data receiving device;
J: moving the icon from the second starting position to the second starting position to the second end position along the moving path according to the second transmission progress on the second user interface; and
K: storing the received data corresponding to the selected icon in the data receiving device.

8. The data transmitting media as recited in claim 7, wherein the first user interface occupies the entire display area of the touch screen of the data transmitting device.

9. The data transmitting media as recited in claim 8, wherein the predetermined position is located on an edge of the first user interface.

10. The data transmitting media as recited in claim 7, wherein the first transmission progress and the second transmission progress are calculated according to the size of selected data, a transmission speed, and a transmission time.

11. The data transmitting media as recited in claim 7, wherein the resolution of the first user interface is equal to that of the second user interface.

12. The data transmitting media as recited in claim 7, wherein step H is performed immediately after step E.
